(19) United States
(12) Patent Application Publication
(10) Pub. No.: US 2017/0126041 A1
(43) Pub. Date: May 4, 2017

(54) CHARGER CIRCUIT

(71) Applicant: ROHM CO., LTD., Ukyo-ku (JP)

(72) Inventor: Takashi SATO, Ukyo-ku (JP)

(21) Appl. No.: 15/408,871

(22) Filed: Jan. 18, 2017

Related U.S. Application Data
(63) Continuation of application No. PCT/JP2015/070149, filed on Jul. 14, 2015.

(30) Foreign Application Priority Data
Jul. 22, 2014 (JP) 2014-149197

(51) Int. Cl. H02J 7/00; H02M 3/04

(52) U.S. Cl. CPC H02J 7/0052; H02M 3/04; H02J 2007/0062; G06F 1/263

(57) ABSTRACT

A charger circuit charges a secondary battery having a multi-cell structure. A step-down charger and a step-up charger receive a bus voltage VBUS, and charge the secondary battery. A PD controller detects whether or not a host adapter that conforms to the PD (Power Delivery) specification has been coupled to a USB port, and determines the bus voltage VBUS and a charging current based on negotiation with the host adapter. A charger detector detects whether or not a host adapter that conforms to the BC (Battery Charging) specification has been coupled to the USB port, and judges the kind of the host adapter based on the electrical state of the USB port. The charger circuit switches the charger to be used, between the step-up charger and the step-down charger, based on the specification to which the host adapter conforms and a profile supported by the host adapter.

### CROSS-REFERENCE TO RELATED APPLICATIONS

This application is a continuation under 35 U.S.C. §120 of PCT/JP2015/070149, filed Jul. 14, 2015, which is incorporated herein reference and which claimed priority to Japanese Application No. 2014-149197, filed Jul. 22, 2014. The present application likewise claims priority under 35 U.S.C. §119 to Japanese Application No. 2014-0149197, filed Jul. 22, 2014, the entire content of which is also incorporated herein by reference.

### BACKGROUND OF THE INVENTION

1. Field of the Invention

The present invention relates to a charger circuit that charges a secondary battery.

2. Description of the Related Art

Battery-driven devices such as cellular phones, PDAs (Personal Digital Assistants), laptop personal computers, portable audio players, etc., include a rechargeable secondary battery and a charger circuit configured to charge the secondary battery in the form of built-in components. Known examples of such charger circuits include an arrangement that charges such a secondary battery using a DC voltage supplied from a USB (Universal Serial Bus) host adapter via a USB cable.

At present, charger circuits to be mounted on mobile devices conform to a specification which is referred to as the “USB Battery Charging Specification” (which will be referred to as the “BC specification” hereafter). There are several kinds of host adapters. In revision 1.2 of the BC specification, the SDP (Standard Downstream Port), DCP (Dedicated Charging Port), and CDP (Charging Downstream Port) have been defined as the kinds of chargers. The current (current capacity) that can be supplied by a host adapter is determined according to the kind of charger. Specifically, the DCP and CDP are defined to provide a current capacity of 1500 mA. Also, the SDP is defined to provide a current capacity of 100 mA, 500 mA, or 900 mA, according to the USB version.

As a next-generation secondary battery charging method or system using USB, a specification which is referred to as the “USB Power Delivery Specification” (which will be referred to as the “PD specification” hereafter) has been developed. The PD specification allows the available power to be dramatically increased up to a maximum of 100 W, as compared with the BC standard, which provides a power capacity of 7.5 W. Specifically, the PD specification allows a USB bus voltage that is higher than 5 V (specifically, 12 V or 20 V). Furthermore, the PD specification allows a charging current that is greater than that defined by the BC specification (specifically, the PD specification allows a charging current of 2 A, 3 A, or 5 A).

In the transition from the BC specification to the PD specification, a mixed environment can be assumed in which host adapters that conform to only the BC specification and host adapters that conform to the PD specification are both in actual use. An electronic device mounting a multi-cell lithium-ion battery requires a DC voltage of 9 V or more. Accordingly, in a case in which a host adapter that conforms to the PD specification is prepared, such an environment allows such a lithium-ion battery to be charged. However, a host adapter that conforms to the BC specification, which supports a bus voltage of only 5 V, is not capable of charging such a secondary battery, which is a problem.

### SUMMARY OF THE INVENTION

An embodiment of the present invention has been made in view of such a situation. Accordingly, it is an exemplary purpose of such an embodiment of the present invention to provide a charger circuit that is capable of charging a given secondary battery regardless of whether a host adapter conforms to the BC specification or the PD specification.

An embodiment of the present invention relates to a charger circuit structured to charge a secondary battery having a multi-cell structure. The charger circuit comprises: a step-down charger structured to receive a bus voltage, which is supplied from a USB (Universal Serial Bus) host adapter to a USB port, and to charge the secondary battery; a step-up charger structured to receive the bus voltage, and to charge the secondary battery; a PD controller structured to detect whether or not a host adapter that conforms to a PD (Power Delivery) specification has been coupled to the USB port, and to determine the bus voltage and a charging current based on negotiation with the host adapter; and a charger detector structured to detect whether or not a host adapter that conforms to a BC (Battery Charging) specification has been coupled to the USB port, and to judge a kind of the host adapter based on an electrical state of the USB port. The charger circuit is structured to be switchable between a step-up charger and a step-down charger, based on a specification to which the host adapter conforms and a profile supported by the host adapter.

With such an embodiment, in a situation in which a given host adapter is capable of supplying a bus voltage that is higher than the full charge state voltage of the secondary battery, the step-down charger is used, and in a situation in which a given host adapter is capable of supplying a bus voltage that is lower than the full charge state voltage of the secondary voltage, the step-up charger is used. This ensures the charging operation for the secondary battery having a multi-cell structure even in a mixed environment in which host adapters that conform to only the BC specification and host adapters that conform to the PD specification are both in actual use.

Also, (i) when a host adapter that conforms to the BC specification has been coupled, or otherwise (ii) when a host adapter that conforms to the PD specification has been coupled, and when the host adapter does not support a profile for the bus voltage that allows the secondary battery having a multi-cell structure to be charged without involving a step-up operation, the step-up charger may be selected.

This allows a suitable charger to be selected according to the bus voltage.

Also, the charger circuit may further comprise a trickle charging path between an output terminal of the step-up charger and the secondary battery such that the trickle charging path is arranged in parallel with a main charging path.

When the secondary battery is in an over-discharge state or in a dead battery state, the step-up charger may be enabled. Also, the charger circuit may be structured to provide trickle charging via the trickle charging path so as to restore the secondary battery from the over-discharge state or the dead battery state.

Also, the trickle charging path may comprise a diode and a resistor arranged in series between the output terminal of the step-up charger and a terminal of the secondary battery.

Also, the charger circuit may further comprise a switch provided on the main charging path. Also, the switch may be structured to turn off in the charging operation via the trickle charging path.

Also, the charger circuit may further comprise a second diode arranged between an output terminal of the step-up charger and a main charging path. Such an arrangement is capable of preventing a reverse current that flows from the battery to the step-up charger.

Another embodiment of the present invention relates to an electronic device. The electronic device may comprise a secondary battery having a multi-cell structure and any one of the aforementioned charger circuits structured to charge the secondary battery.

It is to be noted that any arbitrary combination or rearrangement of the above-described structural components and so forth is effective as and encompassed by the present embodiments. Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing an overall configuration of an electronic device including a charger circuit according to an embodiment;

FIG. 2 is a block diagram showing a configuration of the charger circuit shown in FIG. 1;

FIG. 3 is a circuit diagram showing an example configuration of a USB charger detector;

FIG. 4 is a circuit diagram showing an example configuration of a step-up charger;

FIG. 5 is a circuit diagram showing an example configuration of a step-down charger;

FIG. 6 is a flowchart showing an operation of the charger circuit shown in FIG. 2; and

FIG. 7 is a block diagram showing an electronic device according to a first modification.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is coupled to the member B” includes a state in which the member A is indirectly coupled to the member B via another member that does not substantially affect the electric connection therebetween, or that does not damage the functions or effects of the connection therebetween, in addition to a state in which the member A is physically and directly coupled to the member B.

Similarly, the state represented by the phrase “the member C is provided between the member A and the member B” includes a state in which the member A is indirectly coupled to the member C, or the member B is indirectly coupled to the member C via another member that does not substantially affect the electric connection therebetween, or that does not damage the functions or effects of the connection therebetween, in addition to a state in which the member A is directly coupled to the member C, or the member B is directly coupled to the member C.

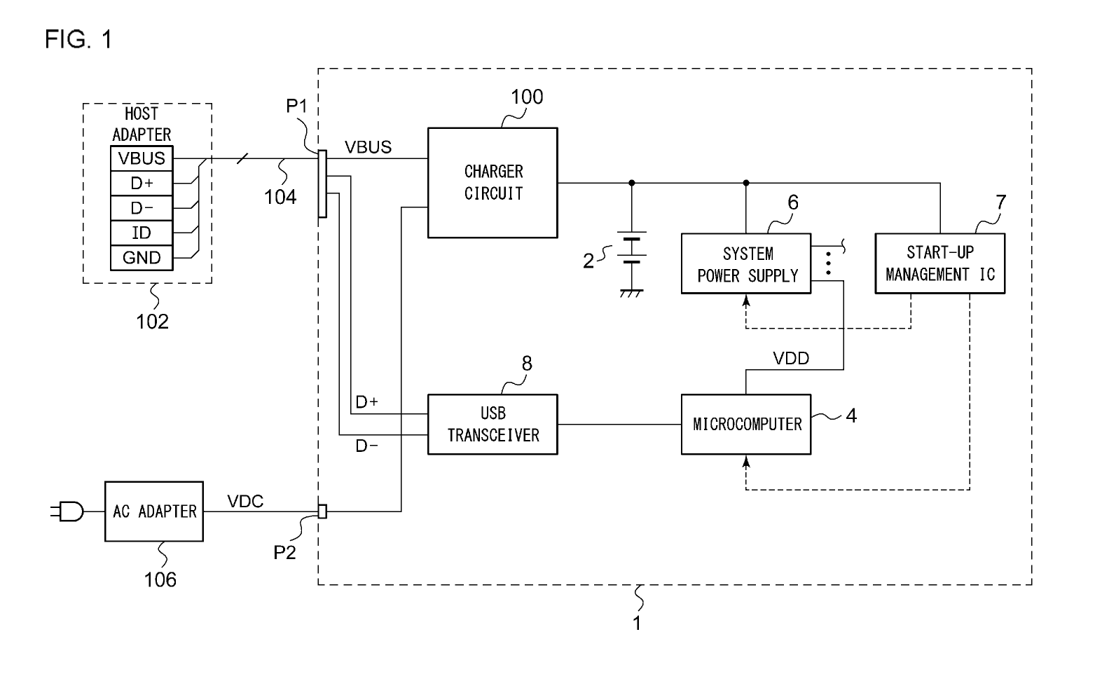

FIG. 1 is a block diagram showing an overall configuration of an electronic device 1 including a charger circuit 100 according to an embodiment. The electronic device 1 is configured as a battery-driven information terminal device such as a cellular phone terminal, a tablet terminal, a laptop PC (Personal Computer), a digital still camera, a digital video camera, or the like. The electronic device 1 includes a secondary battery 2, a microcomputer 4, a system power supply 6, a USB transceiver (USB PHY) 8, and a charger circuit 100.

The secondary battery 2 is configured as a secondary battery such as a lithium-ion battery, a nickel hydride battery, or the like. The secondary battery 2 outputs a battery voltage VBAT. The secondary battery 2 includes multiple (2 or more) cells. In the full charge state, the battery voltage VBAT is on the order of 9 V. The battery voltage in the full charge state will be represented by “VBAT_FULL” hereafter. A USB (Universal Serial Bus) host adapter 102 can be detachably coupled with a USB port P1 of the electronic device 1 via a USB cable 104.

More specifically, a DC voltage (which will also be referred to as the “bus voltage” or “bus power”) VBUS is supplied to the VBUS terminal of the USB port P1 from the host adapter 102. Furthermore, the DP terminal and the DM terminal are coupled with data lines D+ and D− of the USB cable, respectively. The ID terminal is not used in the present embodiment. The GND terminal is coupled with a GND line.

Furthermore, the electronic device 1 includes an adapter port P2 that allows the DC voltage VDC to be input via an AC adapter 106. The rated value of the DC voltage VDC is designed to be a voltage that is higher than the full charge state voltage VBAT_FULL, i.e., to be a voltage of 12 V, for example.

The charger circuit 100 receives either the bus voltage VBUS or the DC voltage VDC, and charges the secondary battery 2 using one of the voltages from among the bus voltage VBUS and the DC voltage VDC.

The microcomputer 4 is configured as a host processor that controls the overall operation of the electronic device 1. In a case in which the electronic device 1 is configured as a wireless communication terminal, the microcomputer 4 corresponds to a baseband processor or an application processor.

The system power supply 6 steps up or otherwise steps down the battery voltage Vbat, so as to generate multiple power supply voltages for respective blocks of the electronic device 1. The microcomputer 4 receives the supply of the power supply voltage VDD generated by the system power supply 6.

When a start-up trigger event is detected in a shutdown state of the electronic device 1, a start-up management IC 7 instructs the system power supply 6 to generate the power supply voltage VDD for each block according to a predetermined sequence. Furthermore, the start-up management IC 7 instructs the microcomputer 4 to execute a predetermined operation.

A USB transceiver 8 performs data transmission and reception between itself and the host adapter 102 via the signal lines D+ and D−.

The above is the schematic configuration of the electronic device 1. Next, description will be made regarding the configuration of the charger circuit 100 according to the embodiment.

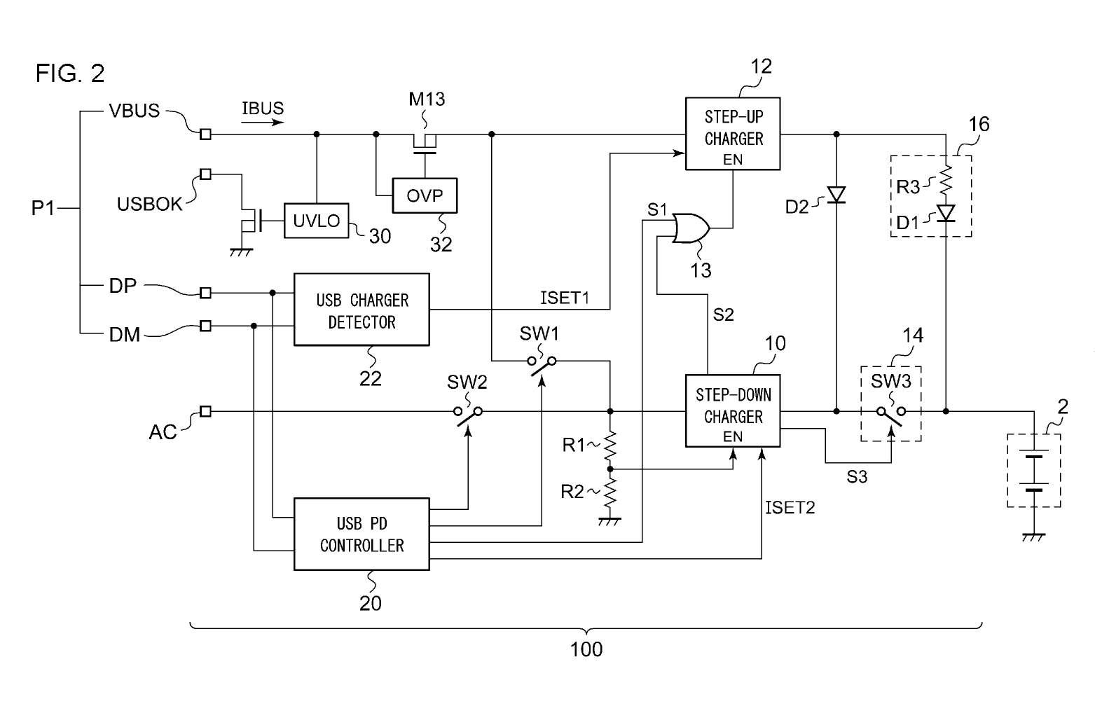

FIG. 2 is a block diagram showing a configuration of the charger circuit 100 shown in FIG. 1. The charger circuit 100 includes a step-down charger 10, a step-up charger 12, a PD controller 20, a USB charger detector 22, a UVLO circuit 30, and an OVP circuit 32, in addition to the USB port P1 and the adapter port P2.

The VBUS terminal, the DP terminal, and the DM terminal are coupled with the USB port P1 shown in FIG. 1. The bus voltage VBUS is input to the VBUS terminal. The DP terminal and the DM terminal are coupled with the data lines D+ and D−, respectively.

The step-down charger 10 is configured to receive the bus voltage VBUS, and to charge the secondary battery 2 via a main charging path 14. The step-down charger 10 may be configured as a linear charger employing a linear power supply. Also, the step-down charger 10 may be configured as a switching charger employing a step-down switching converter.

The step-up charger 12 receives the bus voltage VBUS, and charges the secondary battery 2 via the main charging path 14. The step-up charger 12 is configured as a switching charger employing a step-up switching converter. A second diode D2, which functions as a reverse-current blocking diode, is preferably arranged between the main charging path 14 and the step-up charger 12.

The step-down charger 10 and the step-up charger 12 are each configured to switch their mode between a constant current charging (CC) mode and a constant voltage charging (CV) mode. The charging mode is selected according to the state of the secondary battery 2.

The PD controller 20 judges whether or not a host adapter (which will be referred to as the “host adapter 102a” hereafter) that conforms to the PD (Power Delivery) specification has been coupled with the USB port P1. Subsequently, the PD controller 20 determines the bus voltage VBUS and the bus current IBUS based on negotiation with the host adapter 102a via the data lines D+ and D−.

In the PD specification, the charger circuit 100 and the host adapter 102 each support at least one profile. Examples of such a profile include:

PROFILE 1, which supports 5V@2 A;

PROFILE 2, which supports 5V@2 A, 12V@1.5 A;

PROFILE 3, which supports 5V@2 A, 12V@3 A;

PROFILE 4, which supports 5V@2 A, 12V@3 A, 20V@3 A; and

PROFILE 5, which supports 5V@2 A, 12V@5 A, 20V@5 A.

The PD specification guarantees at least VBUS=5 V and IBUS=2 A for any profile. The PD controller 20 determines the combination of the bus voltage VBUS and the bus current IBUS supported by both the charger circuit 100 and the host adapter 102 based on negotiation with the host adapter 102a.

The USB charger detector 22 judges whether or not a host adapter (which will be referred to as the “host adapter 102b” hereafter) that conforms to the BC (Battery Charging) specification has been coupled with the USB port P1. Furthermore, the USB charger detector 22 detects the kind of the host adapter 102b based on the electrical state of the USB port P1.

More specifically, when the host adapter 102 is coupled with the USB port P1, the USB charger detector 22 detects the kind of the host adapter 102 (which is one from among SDP, DCP, and CDP) based on the electrical state of the data lines D+ and D− of the USB port P1. Furthermore, the USB charger detector 22 determines the upper limit value of the charging current to be supplied by the step-up charger 12.

The data generated by the PD controller 20 and the data generated by the USB charger detector 22 are written to an unshown register. Otherwise, such data are supplied as a notice to the step-up charger 12 and the step-down charger 10. Specifically, the USB charger detector 22 notifies the step-up charger 12 of setting data ISET1 which indicates the upper limit of the charging current thus determined. Similarly, the PD controller 20 notifies the step-down charger 10 of setting data ISET2 which indicates the upper limit of the charging current thus determined.

The UVLO circuit 30 judges whether or not the bus voltage VBUS is equal to or higher than a threshold voltage VUVLO, i.e., judges whether or not the charger circuit 100 can operate using the bus voltage VBUS. A transistor M12 is arranged such that its drain is coupled with the status terminal USBOK, and such that its gate receives, as an input signal, a voltage that corresponds to a judgement result obtained by the UVLO circuit 30. When judgement is made that the bus voltage VBUS is in a normal state, the USBOK terminal is set to a low level. When judgement is made that the bus voltage VBUS is in an overvoltage state or an undervoltage state, the USBOK terminal is set to a high-impedance state. Such an arrangement allows the microcomputer 4 arranged as an external device to the charger circuit 100 to determine with reference to the state of the status terminal USBOK whether or not the DC voltage VUSB is being supplied to the electronic device 1.

The OVP (Over-Voltage Protection) circuit 32 judges whether or not the bus voltage VBUS is higher than a predetermined threshold voltage VOVP. When VBUS>VOVP, the OVP circuit 32 performs an overvoltage protection operation, which turns off a transistor M13.

Furthermore, either the PD controller 20 or the USB charger detector 22 or otherwise another unshown detector monitors the presence or absence of the supply of the DC voltage VDC to the AC terminal.

The charger circuit 100 is configured to be switchable between the step-up charger 12 and the step-down charger 10 based on the specification to which the host adapter 102 conforms (i.e., PD specification or BC specification) and the profile supported by the specification.

Specifically, (i) when the host adapter 102a that conforms to the BC specification is coupled, or (ii) when the host adapter 102b that conforms to the PD specification is coupled and when the host adapter 102b does not support a profile that supports the bus voltage VBUS (9 V or more in the present embodiment) that allows the multi-cell secondary battery 2 to be charged without a voltage step-up operation, the step-up charger 12 is selected.

In other cases, i.e., when (iii) the host adapter 102b that conforms to the PD specification is coupled and when the host adapter 102b supports a profile that supports the bus voltage VBUS (9 V or more in the present embodiment) that allows the multi-cell secondary battery 2 to be charged without a voltage step-up operation, the step-down charger 10 is selected.

Description will be made below regarding an example of such a switching control operation between the step-down charger 10 and the step-up charger 12. The state in which the step-down charger 10 is selected will be referred to as the “step-down charging state φ1, and the state in which the step-up charger 12 is selected will be referred to as the “step-up charging state φ2.

1. Step-Down Charging State φ1

A first switch SW1 is arranged on a path that connects the input terminal of the step-down charger 10 and the VBUS terminal. Furthermore, a second switch SW2 is arranged on a path that connects the input terminal of the step-down charger 10 and the AC terminal.

When the DC voltage VDC is supplied to the AC terminal from the AC adapter 106, the PD controller 20 turns on the second switch SW2 and turns off the first switch SW1. In this case, the secondary battery 2 is charged using the DC voltage VDC supplied from the AC adapter 106.

When the DC voltage VDC is not supplied to the AC terminal from the AC adapter 106, and when the bus voltage VBUS that is higher than the full charge state voltage VBAT_FULL is supplied to the VBUS terminal from the host adapter 102, the PD controller 20 turns on the first switch SW1 and turns off the second switch SW2. In this case, the secondary battery 2 is charged using the bus voltage VBUS supplied form the host adapter 102.

The step-down charger 10 is provided with an enable terminal EN. The bus voltage VBUS is divided by means of resistors R1 and R2, and the voltage thus divided is supplied to the enable terminal EN of the step-down charger 10. When the voltage at the enable terminal EN is higher than a predetermined threshold value, the step-down charger 10 is set to an enable state (operable state).

2. Step-Up Charging State φ2

When the first switch SW1 and the second switch SW2 are both turned off, the step-up charger 12 charges the secondary battery 2 using the bus voltage VBUS.

The step-up charger 12 is also provided with an enable terminal EN. The step-up charger 12 is arranged such that its enable terminal EN receives, via an OR gate 13, a control signal S1 from the PD controller 20 and a control signal S2 from the step-down charger 10.

When the host adapter 102 conforms to the PD specification that supports only the VBUS=5 V profile, the PD controller 20 asserts (sets to the high level, for example) the control signal S1.

When the step-down charger 10 itself alone is not able to charge the secondary battery 2, the step-down charger 10 asserts the control signal S2. Conceivable examples of such a state in which the step-down charger 10 is not able to charge the secondary battery 2 include: a state in which the bus voltage VBUS is lower than the full charge state voltage VBAT_FULL; and a state in which a malfunction or an abnormal state occurs in the step-up charger 10 itself. When at least one of the control signals S1 and S2 is asserted, the step-up charger 12 is enabled.

The charger circuit 100 further includes a trickle charging path 16 between the output terminal of the step-up charger 12 and the secondary battery 2 such that it is arranged in parallel with the main charging path 14. The trickle charging path 16 includes a resistor R3 and a first diode D1, which functions as a reverse-current blocking diode, such that they are arranged in series.

With the charger circuit 100, when the secondary battery 2 is in an over-discharge state or in a dead battery state, the step-up charger 12 is enabled, which allows a trickle charging operation to be performed via the trickle charging path 16. This allows the secondary battery 2 to be restored from the over-discharge state or the dead battery state.

The main charging path 14 includes a switch SW3. When the charging operation is performed via the trickle charging path 16, the switch SW3 is turned off. When the charging operation is performed via the main charging path 14, the switch SW3 is turned on. For example, the switch SW3 is controlled according to a control signal S3 generated by the step-down charger 10.

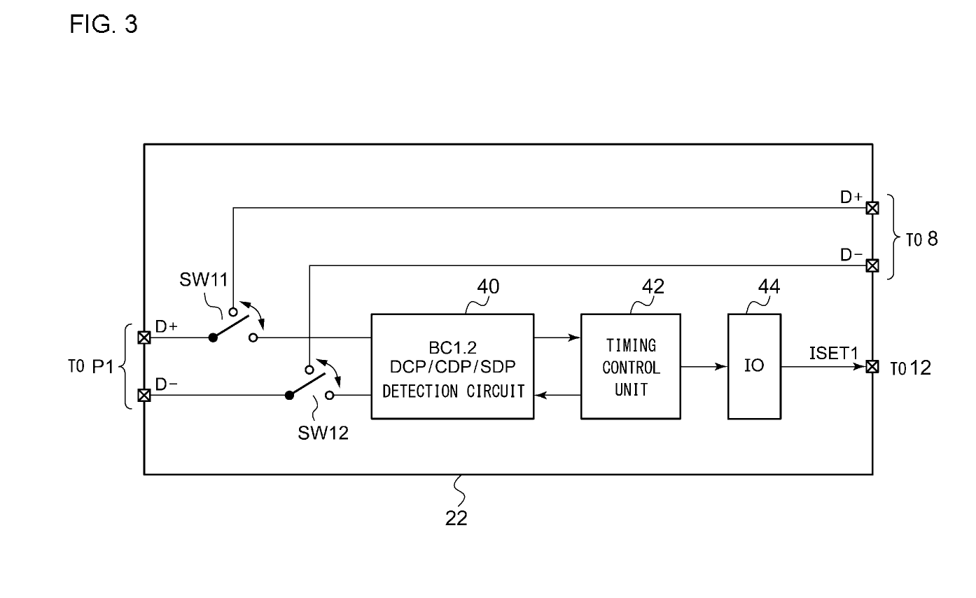

FIG. 3 is a circuit diagram showing an example configuration of the USB charger detector 22. The USB charger detector 22 includes switches SW11 and SW12, a detection circuit 40, a timing control unit 42, and an interface circuit 44.

The switches SW11 and SW12 allow the D+ terminal and the D− terminal of the USB port P1 side to be switched between a first state in which they are coupled with the detection circuit 40 and a second state in which they are coupled with the USB transceiver 8. When judgement is being made by the USB charger detector 22 regarding the kind of the host adapter 102, the switches SW11 and SW12 are set to the first state. After the judgment ends, the switches SW11 and SW12 are set to the second state. In the second state, the detection circuit 40 is disconnected from the host adapter 102.

In the first state, the detection circuit 40 is coupled with the host adapter 102 via the USB port P1. In this state, the detection circuit 40 detects the host adapter 102 that conforms to revision 1.2 of the BC specification, and judges the kind of the host adapter 102 (DCP, CDP, or SDP). The timing control unit 42 includes a sequencer designed so as to support a detection sequence for detecting a host adapter that conforms to revision 1.2 of the BC specification, memory that stores judgment results, a logic circuit that determines the setting data ISET1, and the like. The interface circuit 44 is configured as an interface that notifies the step-up charger 12 of the setting data ISET1 thus determined.

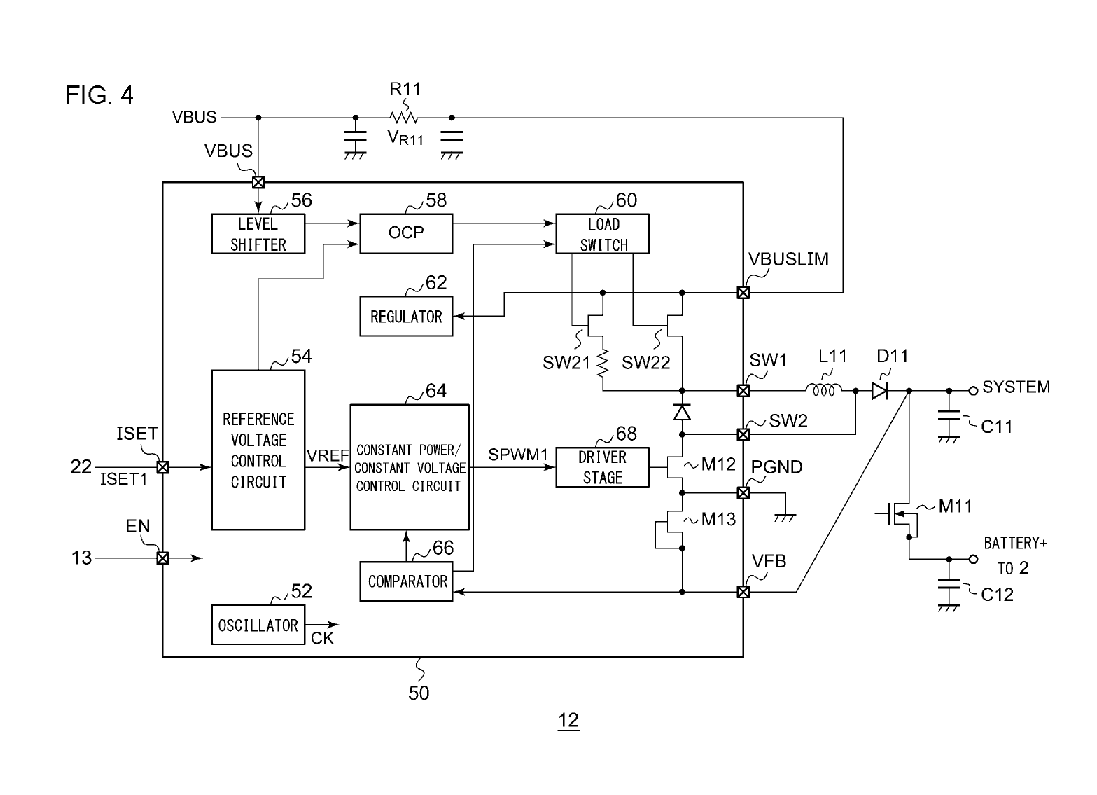

FIG. 4 is a circuit diagram showing an example configuration of the step-up charger 12. The step-up charger 12 includes a controller integrated circuit (IC) 50, and external components, i.e., an inductor L11, a diode D11, a transistor M11, and capacitors C11 and C12.

The inductor L11 is coupled between the SW1 terminal and the SW2 terminal of the controller IC 50. A system (SYSTEM) terminal is coupled with the capacitor C11. The diode D11 is arranged between the inductor L11 and the SYSTEM terminal. The capacitor C12 is coupled with a BATTERY+ terminal. The transistor M11 is arranged between the SYSTEM terminal and the BATTERY+ terminal, which corresponds to the switch SW3 of the main charging path 14 shown in FIG. 2. The transistor M11 is controlled by a control IC 70 included in the step-down charger 10 as described later.

The voltage at the SYSTEM terminal is input to a VFB (feedback) terminal of the controller IC 50. The transistor M13 is arranged between a PGND terminal and the VFB terminal. The transistor controller IC 50 operates using the bus voltage supplied via the VBUS terminal as a power supply. A level shifter 56 shifts the level of the bus voltage VBUS. The bus voltage VBUS is input to a VBUSLIM (VBUS current limit) terminal via a resistor R11. An OCP (overcurrent protection) circuit 58 performs overcurrent state detection, based on the voltage drop V_{R11} that occurs at the resistor R11. A regulator 62 receives the voltage VBUSLIM, and stabilizes the voltage thus received to a predetermined voltage level. The voltage thus stabilized is supplied to each block in the controller IC 50 as a power supply voltage.

The SW1 terminal corresponds to the input of the step-up DC/DC converter. Input switches SW21 and SW22 are arranged between the VBUSLIM terminal and the SW1 terminal, and are controlled by means of a load switch 60. When the step-up charger 12 operates, the input switches SW21 and SW22 are turned on. When the step-up charger 12 does not operate or otherwise when an overcurrent protection operation is performed, the input switches SW21 and SW22 are turned off.

The switching transistor M12 is configured as a switching element of a step-down DC/DC converter. An oscillator 52 generates a clock signal CK. The controller IC 50 controls the switching transistor M12 in synchronization with the clock signal CK.

A reference voltage control circuit 54 generates a reference voltage VREF that corresponds to the setting data ISET1 received from the USB charger detector 22. A comparator 66 receives a feedback voltage VFB, and performs voltage level judgement. A charger controller 64 generates a pulse-modulated signal SPWM1 such that the secondary battery 2 is charged with the current value indicated by the reference voltage VREF as the upper limit. A driver stage 68 switches on and off the switching transistor M12 according to the pulse signal SPWM1. For example, the reference voltage control circuit 54 may be switchable between a constant power (CP) mode and a constant voltage (CV) mode. Alternatively, the reference voltage control circuit 54 may support a constant current (CC) mode.

The above is an example configuration of the step-up charger 12. The controller IC 50 may be configured as a commercially available controller IC, e.g., BD8668## (”##” represents a part model number) from ROHM Co., Ltd.

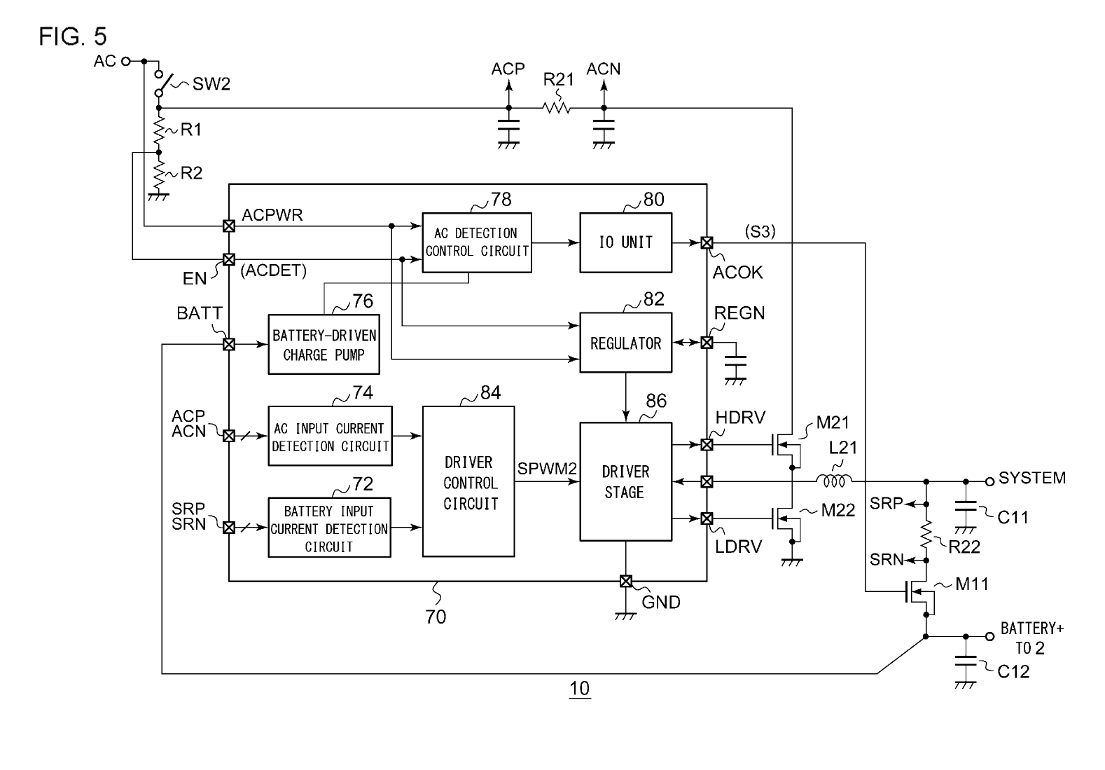

FIG. 5 is a circuit diagram showing an example configuration of the step-down charger 10. A controller IC 70 and external components, i.e., an inductor L21, a switching transistor M21, a synchronous rectification transistor M22, and a capacitor C11, form a step-down DC/DC converter. The capacitors C11 and C12 and the transistor M11 are shared between the step-down charger 10 and the step-up charger 12 shown in FIG. 4.

A charge pump 76 steps up the voltage supplied from the secondary battery 2. An AC detection control circuit 78 detects the presence or absence of the AC adapter 106 based on the voltage at the ACPWR terminal and the EN (ACDET) terminal. An interface circuit 80 outputs the control signal S3 via an ACOK terminal, which indicates the judgement result thus obtained. When the EN terminal is set to the high level, a regulator 82 is set to the active state, which stabilizes the voltage received via the ACPWER terminal. The voltage thus stabilized is supplied as a power supply voltage to a driver stage 86 and the like.

A resistor R22 is arranged on a charging path for charging the secondary battery 2. Both ends of the resistor R22 are coupled with the battery current detection terminals (SRP/SRN) of the controller IC 70. A battery input current detection circuit 72 detects an input current that flows to the secondary battery 2, i.e., a charging current, based on the voltage drop that occurs at the resistor R22.

A resistor R21 is arranged on a path via which a current flows from the AC terminal to the step-down DC/DC converter. Both ends of the resistor R21 are coupled with AC input current detection terminals (ACP/ACN) of the controller IC 70. An AC input current detection circuit 74 detects the input current based on the voltage drop that occurs at the resistor R21.

A driver control circuit 84 generates a pulse-modulated signal SPWM2 based on the detection results obtained by the battery input current detection circuit 72 and the AC input current detection circuit 74. The driver stage 86 switches on and off the transistors M21 and M22 according to the pulse signal SPWM2.

The above is an example configuration of the step-down charger 10. The controller IC 70 may be configured as a commercially available controller IC, e.g., BD99950## from ROHM Co., Ltd.

The above is the configuration of the charger circuit 100. Next, description will be made regarding the operation thereof.

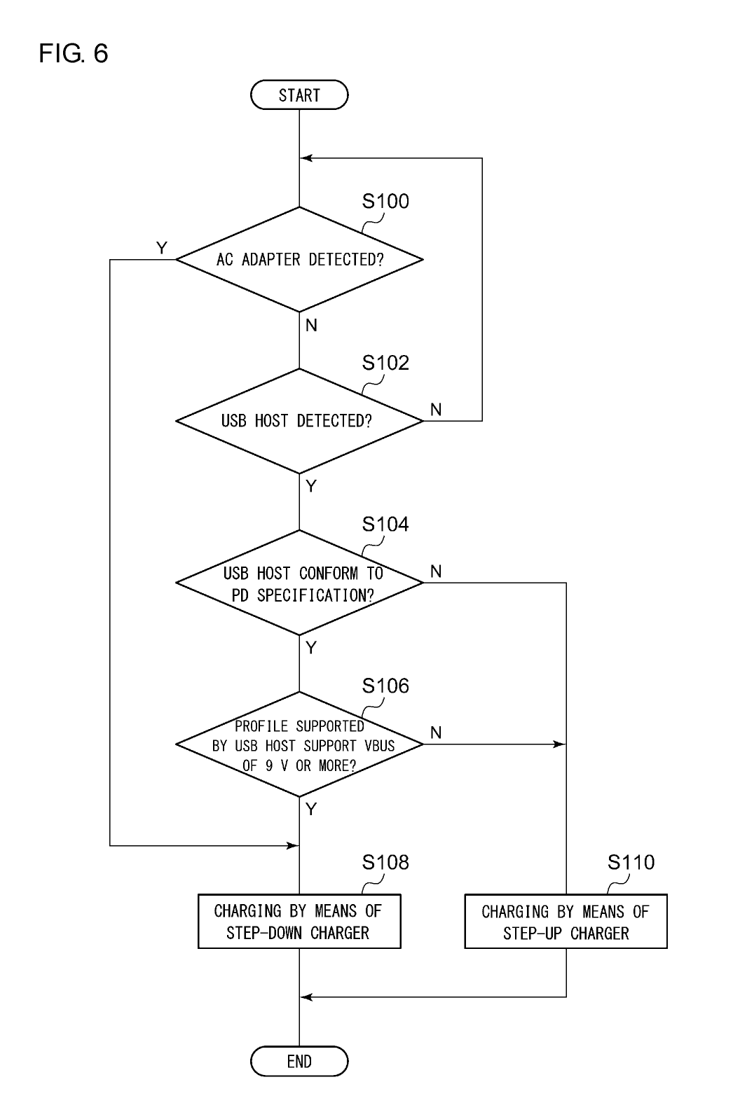

FIG. 6 is a flowchart showing the operation of the charger circuit 100 shown in FIG. 2.

First, judgment is made regarding the presence or absence of the AC adapter 106 (S100). When the AC adapter 106 is detected (YES in S100), the charging operation is started by means of the step-down charger 10 (S108).

When the AC adapter 106 is not detected (NO in S100), judgement is made regarding the presence or absence of the USB host adapter 102 (S102). When the host adapter 102 is not detected, the flow returns to Step 5100 (NO in S102). Subsequently, the detection operations are performed for the host adapter 102 and the AC adapter 106 again (S100 and S102).

When the host adapter 102 is detected (YES in S102), judgment is made regarding whether or not the host adapter 102 conforms to the PD specification (S104). When the host adapter 102 does not conform to the PD specification (NO in S104), i.e., when the host adapter 102 conforms to the BC specification, the charging operation is started by means of the step-up charger 12 (5110).

When the host adapter 102 conforms to the PD specification (YES in S104), profile judgment is performed (S106). When the host adapter 102 supports a profile that provides a voltage that is equal to or higher than the full charge state voltage VBAT_FULL (=9V) (YES in S106), the charging operation is started by means of the step-down charger 10 (S108). When the host adapter 102 does not support a profile that provides a voltage that is equal to or higher than the full charge state voltage (=9V) (NO in S106), the charging operation is performed by means of the step-up charger 12 (S110).

The above is the operation of the charger circuit 100.

With the charger circuit 100, when the host adapter 102 is capable of supplying the bus voltage VBUS that is higher than the full charge state voltage VBAT_FULL of the secondary battery 2, the charging operation is performed using the step-down charger 10. When the supplied bus voltage VBUS has a voltage value that is lower than the full charge state voltage VBAT_FULL of the secondary battery 2, the charging operation is performed using the step-up charger 12. This ensures the charging operation for the secondary battery 2 having a multi-cell structure in a mixed environment in which host adapters that conform to only the BC specification and host adapters that conform to the PD specification are both in actual use. In more detail, when the host adapter 102 conforms to the PD specification, which provides a high-speed charging operation, such an arrangement allows the secondary battery 2 to be charged in a short period of time. Conversely, when the host adapter 102 does not conform to the PD specification, or when the host adapter 102 conforms to the PD specification that supports only a profile that supplies a bus voltage of 5 V, such an arrangement allows the secondary battery 2 to be charged in a sure manner by means of the step-up charger 12.

The present inventor has investigated a circuit (which will be referred to as the “circuit according to a conventional technique” hereafter) having the same configuration except that a typical step-up DC/DC converter having no charging function is provided instead of the step-up charger 12, and the input voltage to be supplied to the input terminal of the step-down charger 10 is selectively switched between the output of the step-up DC/DC converter and the bus voltage VBUS. However, with such a conventional technique, when the bus voltage VBUS of 5 V is supplied, power loss occurs in both the step-up charger 12 and the step-down charger 10. In contrast, with the charger circuit 100 according to the embodiment, the step-up charger 12 having a charging function provides an advantage of allowing such power loss to be reduced.

Furthermore, by providing the trickle charging path 16, when the secondary battery 2 is in a dead battery state or over-discharge state, such an arrangement is capable of performing a trickle charging operation via the trickle charging path 16 by means of the step-up charger 12, thereby restoring the secondary battery 2.

Description has been made above regarding the present invention with reference to the embodiment. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

### First Modification

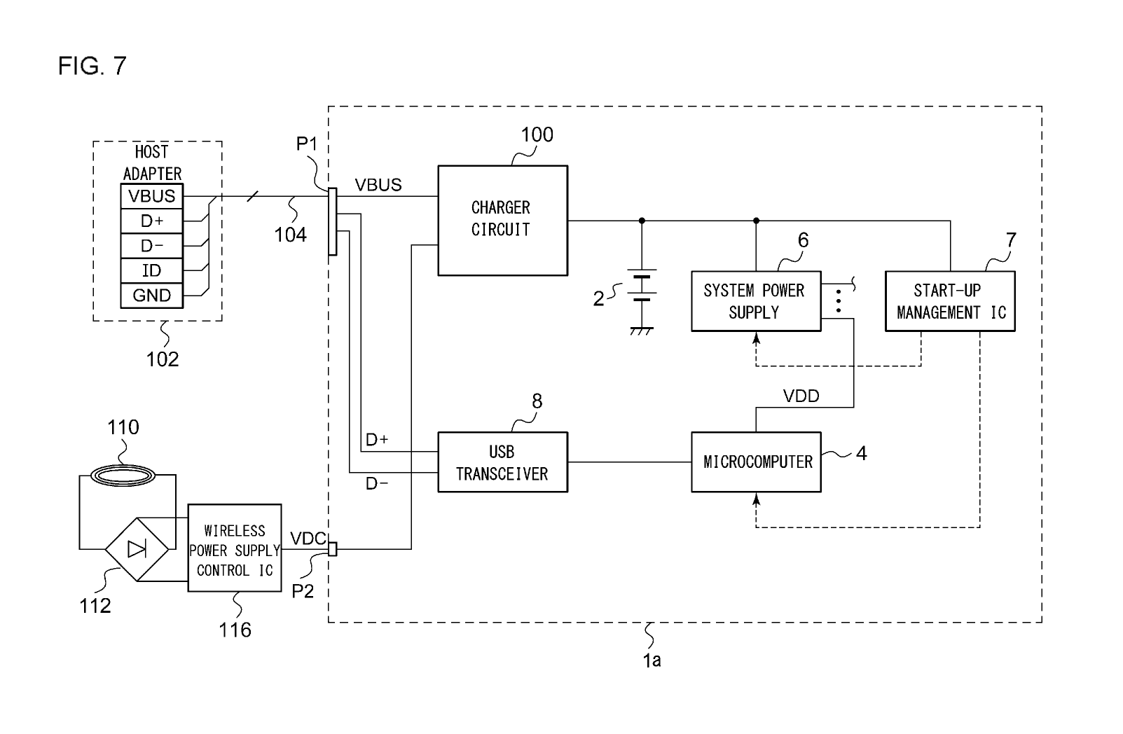

FIG. 7 is a block diagram showing an electronic device according to a first modification. An adapter port P2 of an electronic device la receives the supply of a DC voltage VDC generated by a wireless power supply. Specifically, the adapter port P2 is coupled with a reception coil 110, a rectifier circuit 112, and a wireless power supply control IC 114. The reception coil 110 receives a wireless electric power signal from an unshown transmission coil. The rectifier circuit 112 rectifies and smoothes a current induced at the reception coil 110 according to the wireless electric power signal. The rectifier circuit 112 includes a diode bridge circuit and a smoothing capacitor. Alternatively, the rectifier circuit 112 includes a synchronous rectification circuit (H-bridge circuit) and a smoothing capacitor. The wireless power supply control IC 114 receives a DC voltage from the rectifier circuit 112, and generates the DC voltage VDC stabilized to a predetermined voltage level. The wireless power supply control IC 114 supplies the DC voltage VDC thus generated to the adapter port P2. It should be noted that the diode bridge circuit or the synchronous rectification circuit may be integrated together with the wireless power supply control IC 114. The wireless electric power supply operation may conform to the Qi standard developed by the WPC (Wireless Power Consortium). Also, the wireless electric power supply operation may conform to a standard developed by the PMA (Power Matters Alliance).

### Second Modification

The adapter port P2 is not indispensable. That is to say, the adapter port P2 may be omitted.

### Third Modification

The electronic device 1 shown in FIG. 1 is designed assuming that the USB is also used for data transmission. However, the present invention is not restricted to such an arrangement. Also, the USB may be used for only the charging operation. In this case, the USB transceiver 8 may be omitted.

### Fourth Modification

Description has been made in the embodiment regarding an arrangement in which the charger circuit 100 is built into an electronic device. However, the present invention is not restricted to such an arrangement. For example, the charger circuit 100 may be mounted on a USB charger packaged in the form of a separate housing that differs from the electronic device 1 including the secondary battery 2 as a built-in component.

While the preferred embodiments of the present invention have been described using specific terms, such description is for illustrative purposes only, and it is to be understood that changes and variations may be made without departing from the spirit or scope of the appended claims.

What is claimed is:

1. A charger circuit structured to charge a secondary battery having a multi-cell structure, the charger circuit comprising:
a step-down charger structured to receive a bus voltage, which is supplied from a USB (Universal Serial Bus) host adapter to a USB port, and to charge the secondary battery;
a step-up charger structured to receive the bus voltage, and to charge the secondary battery;
a PD controller structured to detect whether or not a host adapter that conforms to a PD (Power Delivery) specification has been coupled to the USB port, and to determine the bus voltage and a charging current based on negotiation with the host adapter; and
a charger detector structured to detect whether or not a host adapter that conforms to a BC (Battery Charging) specification has been coupled to the USB port, and to judge a kind of the host adapter based on an electrical state of the USB port,
wherein the charger circuit is structured to be switchable between a step-up charger and a step-down charger, based on a specification to which the host adapter conforms and a profile supported by the host adapter.

2. The charger circuit according to claim 1, structured such that (i) when a host adapter that conforms to the BC specification has been coupled, or otherwise (ii) when a host adapter that conforms to the PD specification has been coupled, and when the host adapter does not support a profile for the bus voltage that allows the secondary battery having a multi-cell structure to be charged without involving a step-up operation, the step-up charger is selected.

3. The charger circuit according to claim 1, further comprising a trickle charging path between an output terminal of the step-up charger and the secondary battery such that the trickle charging path is arranged in parallel with a main charging path.

4. The charger circuit according to claim 3, wherein, when the secondary battery is in an over-discharge state or in a dead battery state, the step-up charger is enabled,
and wherein the charger circuit is structured to provide trickle charging via the trickle charging path so as to restore the secondary battery from the over-discharge state or the dead battery state.

5. The charger circuit according to claim 3, wherein the trickle charging path comprises a diode and a resistor arranged in series between the output terminal of the step-up charger and a terminal of the secondary battery.

6. The charger circuit according to claim 3, further comprising a switch provided on the main charging path,
wherein the switch is structured to turn off in the charging operation via the trickle charging path.

7. The charger circuit according to claim 1, further comprising a second diode arranged between an output terminal of the step-up charger and a main charging path.

8. An electronic device comprising:
a secondary battery comprising N (N represents an integer of 2 or more) cells; and
the charger circuit according to claim 1, structured to charge the secondary battery.

9. A charger comprising the charger circuit according to claim 1, structured to charge a secondary battery.
